(19) United States
(12) Patent Application Publication
(10) Pub. No.: US 2015/0063778 A1
(43) Pub. Date: Mar. 5, 2015

(54) METHOD FOR PROCESSING AN IMAGE AND ELECTRONIC DEVICE THEREOF

(71) Applicant: Samsung Electronics Co., Ltd., Gyeonggi-do (KR)

(72) Inventors: Hyuk-Min KWON, Seoul (KR); Young-Gyu Kim, Seoul (KR); Jong-Min Yun, Seoul (KR)

(73) Assignee: Samsung Electronics Co., Ltd.

(21) Appl. No.: 14/449,519

(22) Filed: Aug. 1, 2014

(30) Foreign Application Priority Data
Sep. 4, 2013 (KR) 10-2013-0106255

(51) Int. Cl. H04N 5/232; G11B 27/031; H04N 5/77; H04N 1/00

(52) U.S. Cl. CPC H04N 5/23216; H04N 5/23293; H04N 5/23232; H04N 1/00129; H04N 1/00209; G11B 27/031; H04N 5/77
USPC 386/225; 348/207.11

(57) ABSTRACT

An electronic device and a method thereof that receive an image photographed in a multi-angle and that generate a file are provided. The method includes detecting at least one second electronic device located within a preset distance of a first electronic device; receiving information associated with a second image from the detected at least one second electronic device; and displaying the second image and a first image. The first image is photographed in an angle of the first electronic device, and the second image is photographed in an angle of the detected at least one second electronic device.

### PRIORITY

This application claims priority under 35 U.S.C. §119(a) to a Korean Patent Application filed in the Korean Intellectual Property Office on Sep. 4, 2013 and assigned Serial No. 10-2013-0106255 the entire content of which is incorporated herein by reference.

### BACKGROUND

1. Field of the Invention

The present invention generally relates to a method for processing an image and an electronic device thereof.

2. Description of the Related Art

As functions of an electronic device develop, various functions may be performed with the electronic device. For example, communication may be performed and a subject displayed in the electronic device may be photographed using the electronic device.

### SUMMARY

The present invention has been made to solve at least the above-mentioned problems and/or disadvantages and to provide at least the advantages described below. Accordingly, an aspect of the present invention is to provide an electronic device and a method thereof in which a master electronic device receives information of each image photographed in slave electronic devices, that can control an image photographed in a plurality of angles of slave electronic devices as well as an image photographed in an angle of the master electronic device, that can satisfy a user's various requests.

Another aspect of the present invention is to provide an electronic device and a method thereof that can store an image photographed in a plurality of angles of slave electronic devices as well as an image photographed in an angle of a master electronic device and that can generate a file of a subject photographed in various angles, and that can thus improve a user's convenience.

In accordance with an aspect of the present invention, a method of operating a master electronic device that controls at least one electronic device is provided. The method includes detecting at least one second electronic device located within a preset distance among a first electronic device; receiving information associated with a second image from the detected at least one second electronic device; and displaying the second image and a first image. The first image is photographed in an angle of the first electronic device, and the second image is photographed in an angle of the detected at least one second electronic device.

In accordance with an aspect of the present invention, a first electronic device that controls at least one electronic device is provided. A first electronic device includes a display module; and at least one processor configured to detect at least one second electronic device located within a predetermined distance, to receive information associated with a second image from the detected at least one second electronic device, and to display the second image and a first image. The first image is photographed in an angle of the first electronic device, and the second image is photographed in an angle of the detected at least one second electronic device.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating a configuration of an electronic device according to an embodiment of the present invention;

FIG. 2 is a block diagram illustrating a configuration of hardware according to an embodiment of the present invention;

FIG. 3 is a block diagram illustrating a configuration of a programming module according to an embodiment of the present invention;

FIGS. 4A, 4B, 4C and 4D are diagrams illustrating dividing and displaying a screen of a master electronic device according to the number of slave electronic devices detected by the master electronic device according to a first embodiment of the present invention;

FIGS. 5A, 5B, 5C and 5D are diagrams illustrating dividing and displaying a screen of a master electronic device according to the number of slave electronic devices detected by a master electronic device according to a second embodiment of the present invention;

FIGS. 6A, 6B, 6C are 6D are diagrams illustrating displaying an image received from a plurality of slave electronic devices and storing an image in the selected area according to an embodiment of the present invention;

FIGS. 7A, 7B, 7C and 7D are diagrams illustrating enlarging and deleting a display of an image according to an embodiment of the present invention;

FIGS. 8A, 8B and 8C are diagrams illustrating editing a stored image according to an embodiment of the present invention;

FIG. 9 is a flowchart illustrating an operation of a master electronic device according to an embodiment of the present invention;

FIG. 10 is a flowchart illustrating a method of operating a master electronic device according to an embodiment of the present invention; and

FIGS. 11A, 11B, 11C and 11D are diagrams illustrating enlarging and displaying an image in the selected area according to an embodiment of the present invention.

### DETAILED DESCRIPTION OF EMBODIMENTS OF THE PRESENT INVENTION

Hereinafter, embodiments of the present invention will be described with reference to the accompanying drawings. While the present invention may be implemented in many different forms, specific embodiments of the present invention are shown in the drawings and are described herein in detail, with the understanding that the present specification is to be considered as an exemplification of the principles of the invention and is not intended to limit the invention to the specific embodiments illustrated. Detailed descriptions of well-known functions and structures incorporated herein may be omitted to avoid obscuring the subject matter of the present invention. The same reference numbers are used throughout the drawings to refer to the same or like parts.

An electronic device according to the present invention may be a device having a communication function. For example, the electronic device may be at least one combination of various devices such as a smart phone, a tablet Personal Computer (PC), a mobile phone, an audiovisual phone, an e-book reader, a desktop PC, a laptop PC, a netbook computer, a Personal Digital Assistant (PDA), a Portable Multimedia Player (PMP), a Moving Picture Experts Group layer-3 (MP3) player, a mobile medical equipment, an electronic bracelet, an electronic necklace, electronic accessory, a camera, a wearable device, an electronic clock, a wrist watch, a smart white appliance (e.g., a refrigerator, an air-conditioner, a cleaner, an artificial intelligence robot, a television, a Digital Video Disk (DVD) player, an audio device, an oven, a microwave oven, a washing machine, an air cleaner, and an electronic frame), various medical equipments (e.g., a Magnetic Resonance Angiography (MRA) device, a Magnetic Resonance Imaging (MRI) device, a Computed Tomography (CT) device, a scanning machine, and a ultrasonic wave device), a navigation device, a Global Positioning System (GPS) receiver, an Event Data Recorder (EDR), a Flight Data Recorder (FDR), a set-top box, a television box (e.g., Samsung HomeSync™, Apple TV™, or Google TV™), an electronic dictionary, a vehicle infotainment device, an electronic equipment for a ship (e.g., a navigation device and a gyro compass for a ship), avionics, a security device, electronic clothing, an electronic key, a camcorder, game consoles, a Head-Mounted Display (HMD), a flat panel display device, an electronic album, a portion of furniture or a building/structure having a communication function, an electronic board, an electronic signature receiving device, and a projector, but is not limited thereto.

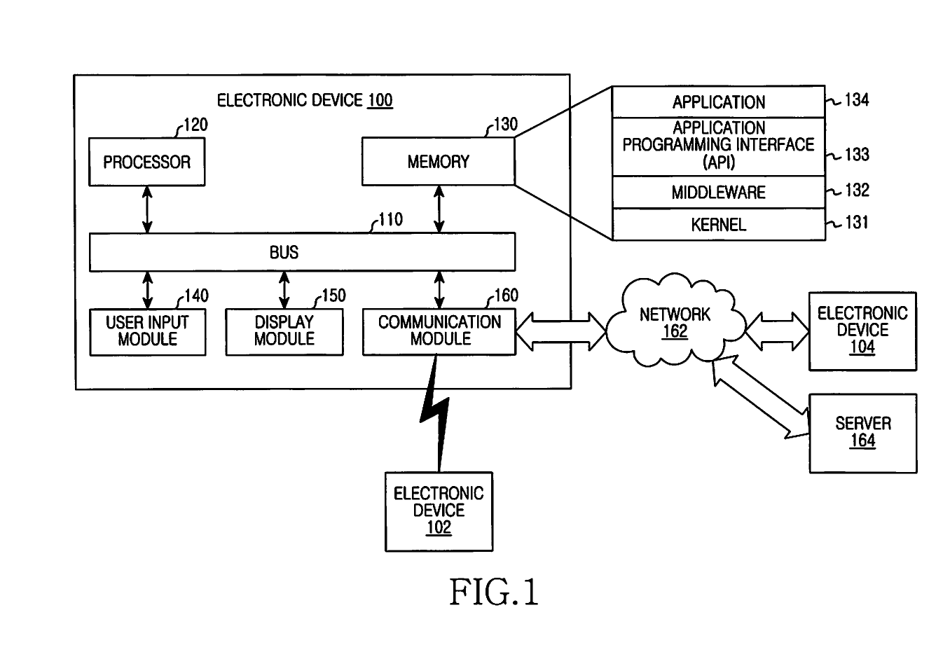

FIG. 1 is a block diagram illustrating a configuration of an electronic device according to an embodiment of the present invention.

Referring to FIG. 1, an electronic device 100 includes a bus 110, a processor 120, a memory 130, a user input module 140, a display module 150, and a communication module 160.

The bus 110 is a circuit that connects the foregoing elements and that transfers communication (e.g., a control message) between the foregoing elements.

The processor 120 receives an instruction from the foregoing another elements (e.g., the memory 130, the user input module 140, the display module 150, and the communication module 170) through, for example, the bus 110, decode the received instruction, and executes a calculation or a data processing according to the decoded instruction.

The memory 130 stores an instruction or data received from the processor 120 or other elements (e.g., the user input module 140, the display module 150, and the communication module 160) or generated by the processor 120 or other elements. The memory 130 may include programming modules such as a kernel 131, middleware 132, an Application Programming Interface (API) 133, or an application 134. The foregoing programming modules may be formed with software, firmware, hardware, or at least two combinations thereof.

The kernel 131 controls or manages system resources (e.g., the bus 110, the processor 120, or the memory 130) used for executing an operation or a function implemented in the remaining programming modules, for example, the middleware 132, the API 133, or the application 134. Further, the kernel 131 may provide an interface that accesses to an individual element of the electronic device 100 in the middleware 132, the API 133, or the application 134 to control or manage the individual element.

The middleware 132 functions as an intermediary that enables the API 133 or the application 134 to communicate with the kernel 131 to transmit and receive data. Further, the middleware 132 may perform load balancing of a work request using a method of aligning a priority that can use a system resource (e.g., the bus 110, the processor 120, or the memory 130) of the electronic device 100 in, for example, at least one application of the plurality of applications 134 in relation to work requests received from the plurality of applications 134.

The API 133 is an interface in which the application 134 can control a function in which the kernel 131 or the middleware 132 provides and may include at least one interface or function for, for example, file control, window control, image processing, or character control.

The user input module 140 receives an input of an instruction or data from a user and transfers the instruction or the data to the processor 120 or the memory 130 through the bus 110. The display module 150 displays a picture, an image, or data to a user.

The communication module 160 connects communication between another electronic device 102 and the electronic device 100. The communication module 160 may support a predetermined short range communication protocol (e.g., Wireless Fidelity (WiFi), Bluetooth (BT), Near Field Communication (NFC)), or communication of a predetermined network 162 (e.g., an Internet, a Local Area Network (LAN), a Wide Area Network (WAN), a telecommunication network, a cellular network, a satellite network, or a Plain Old Telephone Service (POTS)). The electronic devices 102 and 104 each may be the same (e.g., same type) device as the electronic device 100 or may be a device different (e.g., different type) from the electronic device 100.

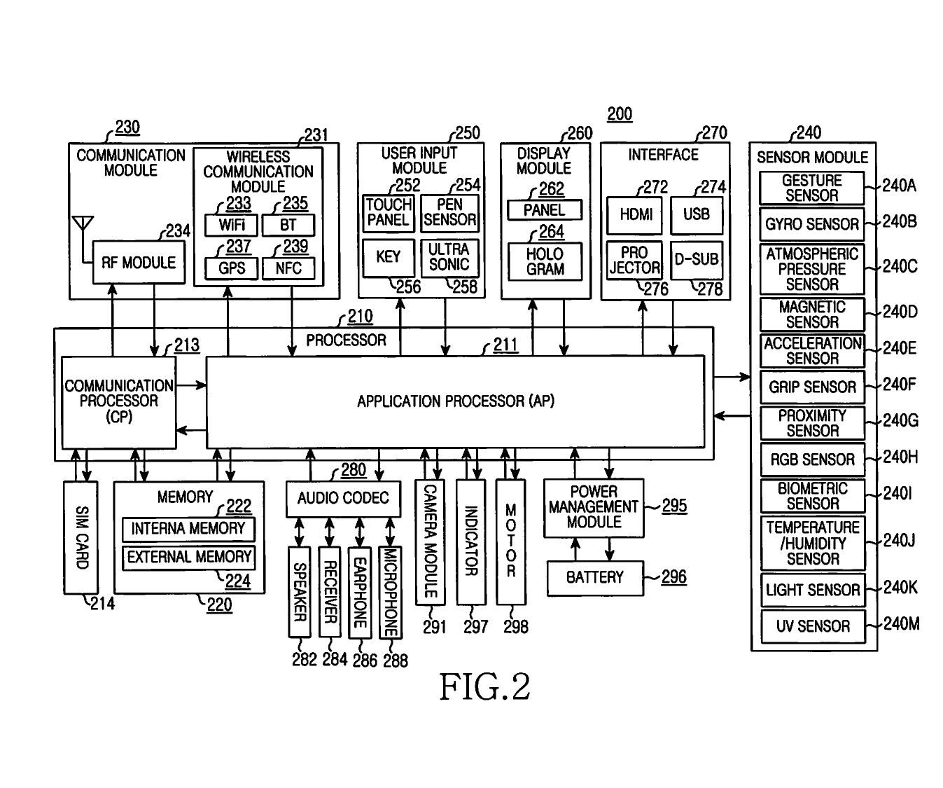

FIG. 2 is a block diagram illustrating a configuration of hardware according to an embodiment of the present invention.

The hardware 200 may be, for example, the electronic device 100 of FIG. 1. Referring to FIG. 2, the hardware 200 includes at least one processor 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, and a motor 298.

The processor 210 includes at least one Application Processor (AP) 211 or at least one Communication Processor (CP) 213. The processor 210 may be, for example, the processor 120 of FIG. 1. In FIG. 2, the AP 211 and the CP 213 are included within the processor 210, but the AP 211 and the CP 213 may be included within different IC packages. The AP 211 and the CP 213 may also be included within an IC package. The processor 210 detects an electronic device located within a preset distance among at least one electronic device. Further, the processor 210 may analyze information of at least one image received from at least one electronic device located within a preset distance. Further, the processor 210 may determine at least one image to be stored among images photographed in at least one angle and generate a moving picture file according to a stored time order of the at least one stored image.

The AP 211 drives an operation system or an applied program to control a plurality of hardware or software elements connected to the AP 211 and performs various data processing and calculation including multimedia data. The AP 211 may be implemented with, for example, a System on Chip (SoC). The processor 210 may further include a Graphic Processing Unit (GPU).

The CP 213 performs a function of managing a data link in communication between an electronic device (e.g., the electronic device 100) including the hardware 200 and another electronic device connected by a network and a function of converting a communication protocol. The CP 213 may be implemented with, for example, a SoC. The CP 213 may perform at least a portion of a multimedia control function. The CP 213 may perform identification and authentication of a terminal within a communication network using, for example, a Subscriber Identification Module (e.g., the SIM card 214). Further, the CP 213 may provide services such as audio dedicated communication, audiovisual communication, a text message, or packet data to the user.

The CP 213 controls data transmission and reception of the communication module 230. In FIG. 2, elements of the CP 213, the power management module 295, or the memory 220 are elements separate from the AP 211, but the AP 211 may include at least a portion (e.g., the CP 213) of the foregoing elements.

The AP 211 or the CP 213 may load and process an instruction or data received from at least one of a non-volatile memory connected to each thereof and another element in a volatile memory. Further, the AP 911 or the CP 213 may store data received from at least one of other elements or generated by at least one of other elements at a non-volatile memory.

The SIM card 214 is a card that implements a subscriber identification module and be inserted into a slot formed in a specific location of an electronic device. The SIM card 214 may include intrinsic identification information (e.g., Integrated Circuit Card Identifier (ICCID)) or subscriber information (e.g., International Mobile Subscriber Identity (IMSI)).

The memory 220 includes a built-in memory 222 or a removable memory 224. The memory 220 may be, for example, the memory 130 of FIG. 1. The built-in memory 222 includes at least one of, for example, a volatile memory (e.g., a Dynamic RAM (DRAM), a static RAM (SRAM), a Synchronous Dynamic RAM (SDRAM)), or a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, and a NOR flash memory). The built-in memory 222 may be a Solid State Drive (SSD). The removable memory 224 includes a flash drive, for example, a Compact Flash (CF), Secure Digital (SD), Micro Secure Digital (Micro-SD), Mini Secure Digital (Mini-SD), extreme Digital (xD), or a memory stick. The memory 220 may store an image photographing in a present angle in real time and may store an image photographing in a selected area.

The communication module 230 includes a wireless communication module 231 or a Radio Frequency (RF) module 234. The communication module 230 may be, for example, the communication module 160 of FIG. 1. The wireless communication module 231 includes, for example, a WiFi module 233, a Bluetooth (BT) module 235, a GPS module 237, or a Near Field Communication (NFC) module 239. The wireless communication module 231 may provide a wireless communication function using a radio frequency. The wireless communication module 231 may further include a network interface (e.g., a LAN card) or a modem for connecting the hardware 200 to a network (e.g., an Internet, a LAN, a WAN, a telecommunication network, a cellular network, a satellite network, or a POTS). The communication module 230 receives information of at least one image photographed in each angle from at least one detected electronic device. Further, the communication module 230 performs short range communication with at least one electronic device located within a preset distance. Further, the communication module 230 requests information of an image photographed in each electronic device, from at least one detected electronic device.

The RF module 234 performs transmission and reception of data, for example, transmission and reception of an RF signal or a called electronic signal. Although not shown, the RF module 234 includes, for example, a transceiver, a Power Amp Module (PAM), a frequency filter, or a Low Noise Amplifier (LNA). Further, the RF module 234 may further include a component, for example, a conductor or a leading wire for transmitting and receiving electromagnetic waves on free space in wireless communication.

The sensor module 240 includes at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a Red, Green, and Blue (RGB) sensor 240H, a bio sensor 240I, a temperature/humidity sensor 240J, an illumination sensor 240K, and a Ultra Violet (UV) sensor 240M. The sensor module 240 measures a physical quantity or detects an operation state of an electronic device and convert measured or detected information to an electric signal. The sensor module 240 may further include, for example, an E-nose sensor, an ElectroMyoGraphy sensor (EMG sensor), an ElectroEncephaloGram sensor (EEG sensor), an ElectroCardioGram sensor (ECG sensor), or a fingerprint sensor. The sensor module 240 may further include a control circuit that controls at least one sensor belonging to the inside.

The user input module 250 includes a touch panel 252, a (digital) pen sensor 254, a key 256, or an ultrasonic wave input device 258. The user input module 250 may be, for example, the user input module 140 of FIG. 1. The touch panel 252 recognizes a touch input with at least one method of, for example, a capacitive, resistive, infrared ray, or ultrasonic wave method. The touch panel 252 may further include a controller. When the touch panel 252 is a capacitive type touch panel, the touch panel 252 may perform a direct touch or proximity recognition. The touch panel 252 may further include a tactile layer. In this case, the touch panel 252 may provide a haptic reaction to the user.

The (digital) pen sensor 254 may be implemented using the same method as and a method similar to, for example, reception of a touch input of the user or a separate recognition sheet. For example, a keypad or a touch key may be used as the key 256. The ultrasonic wave input device 258 is a device that can determine data by detecting a sound wave with a microphone (e.g., a microphone 288) in a terminal through a pen that generates an ultrasonic wave signal and may perform wireless recognition. The hardware 200 may receive a user input from an external device (e.g., a network, a computer, or a server) connected to the communication module 230 using the communication module 230.

The display module 260 includes a panel 262 or a hologram 264. The display module 260 may be, for example, the display module 150 of FIG. 1. The panel 262 may be, for example, a Liquid-Crystal Display (LCD) or an Active-Matrix Organic Light-Emitting Diode (AM-OLED). The panel 262 may be implemented with, for example, a flexible, transparent, or wearable method. The panel 262 and the touch panel 252 may be formed in one module. The hologram 264 may show a stereoscopic image in the air using interference of light. The display module 260 may further include a control circuit that controls the panel 262 or the hologram 264. The display module 260 displays at least one image photographing in each angle and an image photographing in a present angle.

Further, the display module 260 receives an input of an instruction that instructs to photograph a displaying subject and divide and display an image photographing in a present angle and at least one image photographing in each angle at a preset location. Further, the display module 260 receives selection of any one area of at least two areas that divide and display at least one image photographing in each angle and an image photographing in a present angle and enlarge or reduce and display the selected area by a preset size. Further, the display module 260 receives a selection of any one area of at least two areas that divide and display at least one image photographing in each angle and an image photographing in a present angle and terminate display of the selected area. Further, the display module 260 receives a selection of any one area of at least one area in which at least one image photographing in each angle is being displayed. Further, the display module 260 receives an input of an instruction that instructs to edit at least one image photographed in at least one angle.

The interface 270 includes, for example, a High-Definition Multimedia Interface (HDMI) 272, a Universal Serial Bus (USB) 274, a projector 276, or a D-SUBminiature (D-SUB) 278. The interface 270 may further include, for example, Secure Digital (SD)/Multi-Media Card (MMC) or Infrared Data Association (IrDA).

The audio codec 280 converts a sound and an electronic signal in two-ways. The audio codec 280 converts sound information input or output through, for example, a speaker 282, a receiver 284, an earphone 286, or a microphone 288.

The camera module 291 is a device that can photograph an image and a moving picture and includes at least one image sensor (e.g., a front surface lens or a rear surface lens), an Image Signal Processor (ISP), or a flash Light-Emitting Diode (LED).

The power management module 295 manages power of the hardware 200. Although not shown, the power management module 295 includes, for example, a Power Management Integrated Circuit (PMIC), a charger Integrated Circuit (charge IC), or a battery fuel gauge.

The PMIC may be mounted within, for example, an integrated circuit or a SoC semiconductor. A charging method may be classified into a wired method and a wireless method. The charger IC charges a battery and prevents an overvoltage or an overcurrent from being injected from a charging device. The charger IC includes a charger IC for at least one of a wired charge method and a wireless charge method. A wireless charge method includes, for example, a magnetic resonance method, a magnetic induction method, or an electromagnetic wave method and may add an additional circuit, for example, a circuit such as a coil loop, a resonant circuit, and a rectifier for wireless charge.

The battery gauge measures, for example, a residual quantity of the battery 296 and a voltage, a current, or a temperature while charging. The battery 296 generates electricity to supply power and may be, for example, a rechargeable battery.

The indicator 297 displays a specific state, for example, a booting state, a message state, or a charge state of the hardware 200 or a portion (e.g., the AP 211) thereof. The motor 298 converts an electrical signal to a mechanical vibration. A Main Control Unit (MCU) may control the sensor module 240.

Although not shown, the hardware 200 may include a processing device (e.g., GPU) for supporting a mobile TV. The processing device for supporting the mobile TV may process media data according to a specification of, for example, Digital Multimedia Broadcasting (DMB), Digital Video Broadcasting (DVB), or media flow.

A name of the foregoing elements of hardware according to the present invention may be changed according to a kind of an electronic device. Hardware according to the present invention may include at least one of the foregoing elements and may be formed in a form in which some elements are omitted or may further include additional another element. Further, when some of elements of hardware according to the present invention are coupled to form an entity, the entity may equally perform a function of corresponding elements before coupling.

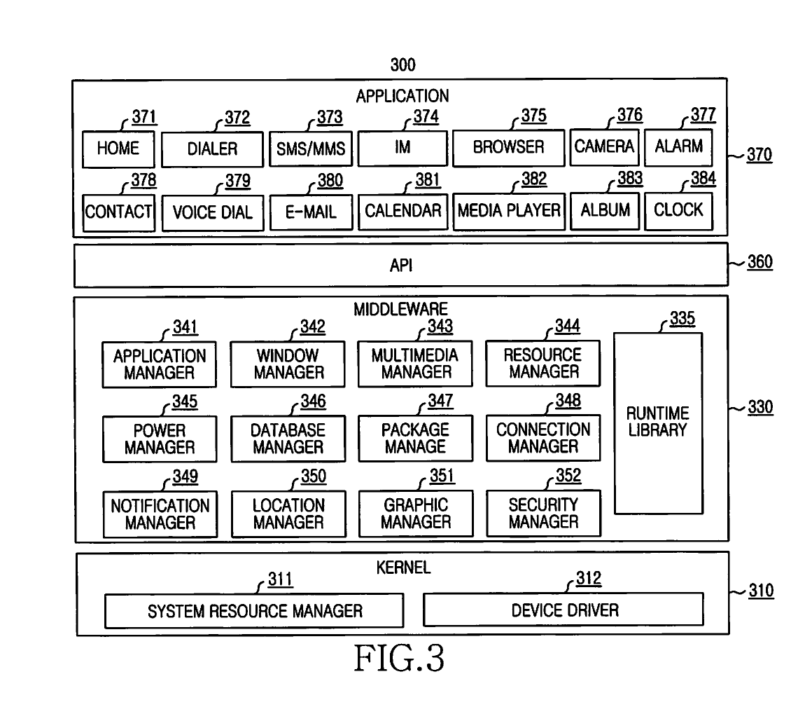

FIG. 3 is a block diagram illustrating a configuration of a programming module according to an embodiment of the present invention.

A programming module 300 may be included (e.g., stored) in the electronic device 100 (e.g., the memory 130) of FIG. 1. At least a portion of the programming module 300 may be formed with software, firmware, hardware or a combination of at least two thereof. The programming module 300 may include an Operation System (OS) implemented in hardware (e.g., the hardware 200 of FIG. 2) to control a resource related to the electronic device (e.g., the electronic device 100 of FIG. 1) or various applications (e.g., an application 370) to be driven on an operation system. For example, the operation system may be Android, iOS, Windows, Symbian, Tizen, or Bada. Referring to FIG. 3, the programming module 300 includes a kernel 310, middleware 330, an API 360, and the application 370.

The kernel 310 (e.g., the kernel 131 of FIG. 1) includes a system resource manager 311 and a device driver 312. The system resource manager 311 includes, for example, a process management unit, a memory management unit, or a file system management unit 317. The system resource manager 311 performs the control, allocation, or recovery of a system resource. The device driver 312 includes, for example, a display driver 314, a camera driver, a Bluetooth driver, a sharing memory driver, a USB driver, a keypad driver, a WiFi driver, or an audio driver. The device driver 312 may further include an Inter-ProcessC (IPC) driver.

In order to provide a function in which the application 370 commonly requires, the middleware 330 may include a plurality of previously implemented modules. Further, in order to enable the application 370 to efficiently use a limited system resource of the inside of the electronic device, the middleware 330 may provide a function through the API 360. For example, as shown in FIG. 3, the middleware 330 (e.g., the middleware 132 of FIG. 1) includes at least one of a run-time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

In order to add a new function through a programming language while, for example, the application 370 is being executed, the run-time library 335 may include a library module which a compiler uses. The run-time library 335 may perform a function of an input and output, memory management, or an arithmetic function.

The application manager 341 manages a life cycle of at least one application of, for example, the applications 370. The window manager 342 manages a GUI resource using on a screen. The multimedia manager 343 grasps a format necessary for reproduction of various media files and perform encoding or decoding of a media file using a codec appropriate to a corresponding format. The resource manager 344 manages a resource such as a source code, a memory, or a storage space of at least one of the applications 370.

The power manager 345 manages a battery or a power source by operating together with a Basic Input/Output System (BIOS) and provides power information necessary for operation. The database manager 346 manages a database so as to generate, search for, or change the database to be used in at least one of the applications 370. The package manager 347 manages installation or update of an application distributed in a package file form.

The connectivity manager 348 manages wireless connection of, for example, WiFi or Bluetooth. The notification manager 349 displays or notifies an event of an arrival message, appointment, and proximity notification with a method of not disturbing a user. The location manager 350 manages location information of the electronic device. The graphic manager 351 manages a graphic effect to be provided to a user or a user interface related thereto. The security manager 352 provides a security function necessary for system security or user authentication. When the electronic device (e.g., the electronic device 100 of FIG. 1) has a phone function, the middleware 330 may further include a telephony manager for managing an audio dedicated communication or audiovisual communication function of the electronic device.

The middleware 330 generates and uses a new middleware module through a combination of various functions of the foregoing internal element modules. In order to provide a differential function, the middleware 330 may provide a module specialized on a kind basis of an operation system. Further, the middleware 330 may dynamically delete a portion of an existing element or may add a new element. Therefore, the middleware 330 may omit a portion of elements described here, may further include other elements, or may be replaced with an element that performs a similar function and that has another name.

The API 360 (e.g., the API 133 of FIG. 1) is a set of API programming functions and may be provided in another element according to an operation system. For example, in Android or IOS, for example, an API set may be provided on a platform basis, and in Tizen, for example, two or more API sets may be provided.

The application 370 (e.g., the application 134 of FIG. 1) includes, for example, a preload application or a third party application.

At least a portion of the programming module 300 may be implemented with an instruction stored at computer-readable storage media. When an instruction is executed by at least one processor (e.g., the processor 210 of FIG. 2), at least one processor performs a function corresponding to an instruction. The computer-readable storage media may be, for example, the memory 220 of FIG. 2. At least a portion of the programming module 300 may be implemented (e.g., executed) by, for example, the processor 210 of FIG. 2. At least a portion of the programming module 300 may include, for example, a module, a program, a routine, sets of instructions, or a process for performing at least one function.

A name of elements of a programming module (e.g., the programming module 300) according to an embodiment of the present invention may be changed according to a kind of an operation system. Further, a programming module according to an embodiment of the present invention may include at least one of the foregoing elements, may be elements in which a portion thereof is omitted, or may further include an additional element.

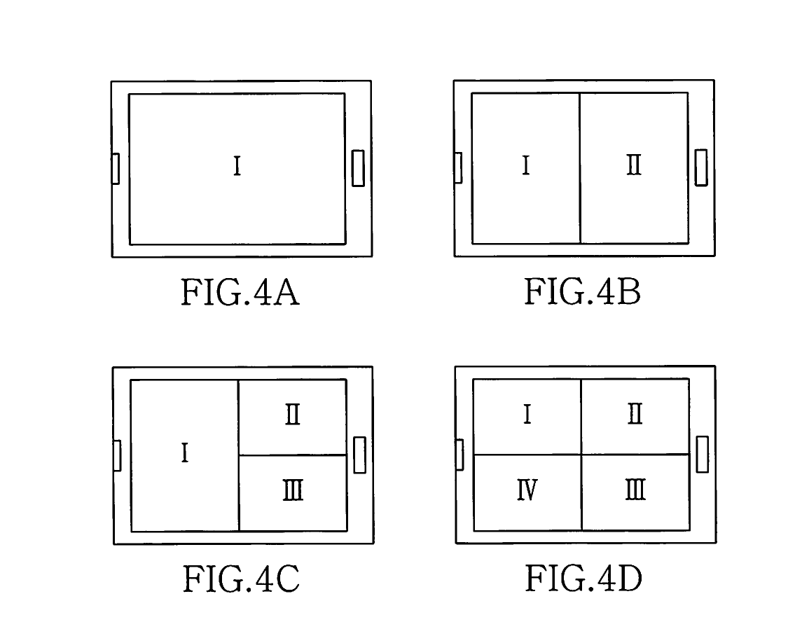

FIGS. 4A, 4B, 4C and 4D are diagrams illustrating dividing and displaying a screen of a master electronic device according to the number of slave electronic devices detected by the master electronic device according to a first embodiment of the present invention. Here, an electronic device includes a master electronic device that can detect and control at least one slave electronic device and at least one slave electronic device that can be detected by the master electronic device and can receive the control of the master electronic device.

First, in the master electronic device, before photographing a moving picture, a Wide Video Graphic Array (WVGA) may be set to a default resolution value to photograph a moving picture. Further, before photographing a moving picture, the master electronic device may receive selection of any one resolution of a plurality of resolutions to photograph a moving picture. For example, the master electronic device may receive selection of any one resolution of a WVGA, High Definition (HD), and Full HD to be a resolution of a moving picture.

When the master electronic device receives an input of an instruction that instructs to photograph a moving picture, the master electronic device displays a subject photographed in a present angle of the master electronic device on a touch screen of the master electronic device. For example, as shown in FIG. 4A, the master electronic device displays a subject photographed in a present angle in an entire touch screen area of the master electronic device according to a preset resolution.

When the master electronic device detects a second electronic device among a preset plurality of slave electronic devices, the master electronic device requests to transmit information of an image photographed in a present angle of the second electronic device to the second electronic device that performs short range communication with the master electronic device.

When the master electronic device receives information of an image photographed in the second electronic device from the second electronic device, the master electronic device divides and displays a first image I photographed with a preset resolution in a present angle of the master electronic device and a second image II photographed with a preset resolution in an angle of the second electronic device on the touch screen of the master electronic device.

For example, as shown in FIG. 4B, when the master electronic device receives information of an image from the second electronic device while displaying only a first image I on the touch screen of the master electronic device, the master electronic device divides the touch screen and displays the first image I and the second image II in the left side and the right side, respectively. That is, the master electronic device divides the touch screen and displays both an image I of a subject photographed in an angle of the master electronic device and an image II of a subject photographed in an angle of the second electronic device on the touch screen of the master electronic device.

When the master electronic device detects a third electronic device among a preset plurality of slave electronic devices, the master electronic device requests to transmit information of an image photographed in a present angle of the third electronic device to the third electronic device performing short range communication with the master electronic device.

When the master electronic device receives information of an image photographed in the third electronic device from the third electronic device, the master electronic device divides the touch screen and displays a first image I photographed according to a preset resolution in an angle of the master electronic device, a second image II photographed according to a preset resolution in an angle of the second electronic device, and a third image III photographed according to a preset resolution in an angle of the third electronic device on the touch screen of the master electronic device.

For example, as shown in FIG. 4C, when the master electronic device receives information of an image from the third electronic device while displaying the first image I and the second image II on the touch screen of the master electronic device, the master electronic device divides the touch screen and displays the first image I in the left side, the second image II in an upper portion of the right side, and the third image III in a lower portion of the right side on the touch screen of the master electronic device.

Similarly, as shown in FIG. 4D, when the master electronic device receives information of an image from a fourth electronic device, the master electronic device divides the touch screen and displays the first image I to a fourth image IV on the touch screen of the master electronic device.

Here, the master electronic device detects the second electronic device to the fourth electronic device, but the master electronic device may detect five or more electronic devices and display an image photographed in various angles of five or more electronic devices.

Further, when the master electronic device displays images photographed in each electronic device, the master electronic device may divide the screen and display the images on the screen clockwise or counterclockwise, according to a user's setting.

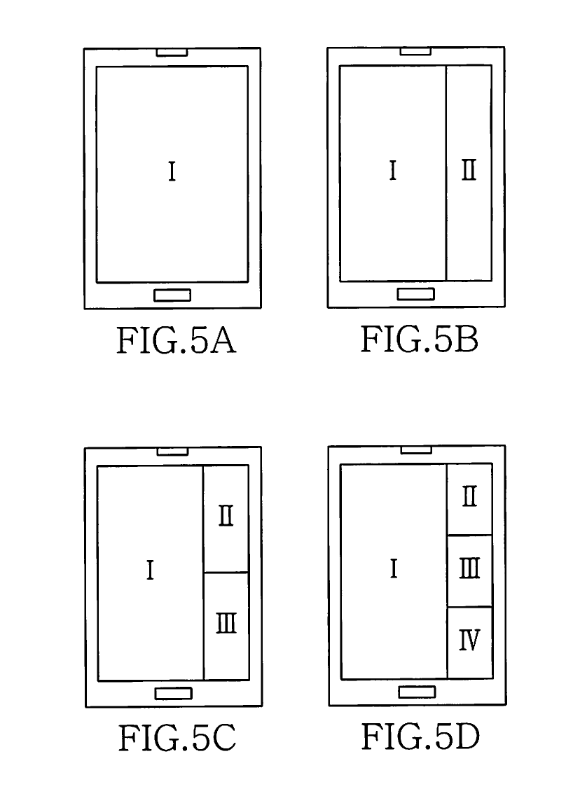

FIGS. 5A, 5B, 5C and 5D are diagrams illustrating dividing and displaying a screen of a master electronic device according to the number of slave electronic devices detected by the master electronic device according to a second embodiment of the present invention.

When the master electronic device receives an input of an instruction that instructs to photograph a moving picture, the master electronic device displays a subject photographed in a present angle on a touch screen of the master electronic device according to a preset resolution. For example, as shown in FIG. 5A, the master electronic device displays a subject photographed in a present angle of the master electronic device in an entire touch screen area of the master electronic device.

When the master electronic device detects the second electronic device among a preset plurality of slave electronic devices, the master electronic device requests to transmit information of an image photographed in a present angle of the second electronic device to the second electronic device performing short range communication with the master electronic device.

When the master electronic device receives information of an image photographed in the second electronic device from the second electronic device, the master electronic device divides the touch screen and displays a first image I photographed according to a preset resolution in a present angle of the master electronic device and a second image II photographed according to a preset resolution in an angle of the second electronic device on the touch screen of the master electronic device.

For example, as shown in FIG. 5B, when the master electronic device receives information of an image from the second electronic device while displaying only the first image I on the touch screen of the master electronic device, the master electronic device divides the touch screen and displays the first image I and the second image II in the left side and the right side, respectively. That is, the master electronic device divides the touch screen and displays both an image I of a subject photographed in an angle of the master electronic device and an image II of a subject photographed in an angle of the second electronic device on the touch screen of the master electronic device. That is, an image I photographed in an angle of the master electronic device is displayed in an area larger than an image II photographed in a slave electronic device so as to represent great importance.

When the master electronic device detects the third electronic device among a preset plurality of slave electronic devices, the master electronic device requests to transmit information of an image photographed in a present angle of the third electronic device to the third electronic device performing short range communication with the master electronic device.

When the master electronic device receives information of an image photographed in the third electronic device from the third electronic device, the master electronic device divides the touch screen and displays a first image I photographed according to a preset resolution in a present angle of the master electronic device, a second image II photographed according to a preset resolution in an angle of the second electronic device, and a third image III photographed according to a preset resolution in an angle of the third electronic device on the touch screen of the master electronic device.

For example, as shown in FIG. 5C, when the master electronic device receives information of an image from the third electronic device while displaying the first image I and the second image II on the touch screen of the master electronic device, the master electronic device divides the touch screen and displays the first image I in a wide area of the left side, the second image II in an upper portion of a narrow area of the right side, and the third image III in a lower portion of a narrow area of the right side on the touch screen of the master electronic device.

Similarly, as shown in FIG. 5D, when the master electronic device receives information of an image from the fourth electronic device, the master electronic device divides the touch screen and displays the first image I to the fourth image IV on the touch screen of the master electronic device.

Here, the master electronic device detects the second electronic device to the fourth electronic device, but the master electronic device may detect five or more electronic devices and display an image photographed in various angles of five or more electronic devices.

Further, when the master electronic device displays images photographed in each electronic device, the master electronic device may divide the screen and display the images on the screen clockwise, or counterclockwise, according to a user's setting.

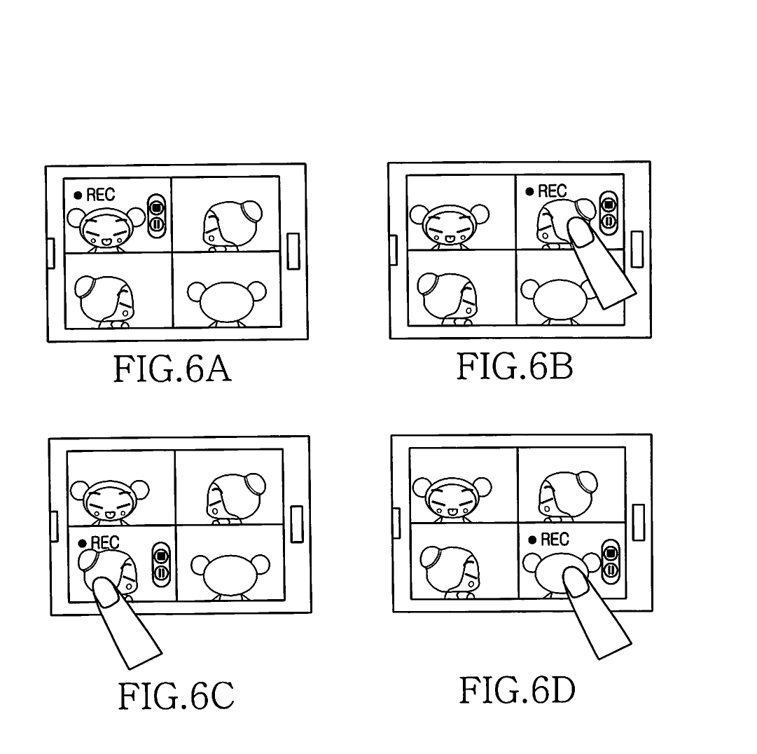

FIGS. 6A, 6B, 6C and 6D are diagrams illustrating displaying an image in which a master electronic device receives from a plurality of slave electronic devices and storing a selected image according to an embodiment of the present invention. Hereinafter, a case in which the master electronic device is performing short range communication with three slave electronic devices, and the master electronic device is photographing a front surface of a specific subject and three slave electronic devices are photographing the left side, the right side, and a rear surface of a specific subject, will be described.

The master electronic device divides the touch screen and displays an image photographed in the master electronic device according to each preset resolution and images photographed in an angle of each slave electronic device from the second electronic device to the fourth electronic device on the touch screen of the master electronic device.

For example, as shown in FIG. 6A, the master electronic device divides the touch screen, displays a front surface of a subject photographed in the master electronic device in an upper portion of the left side, and displays the left side of a subject photographed in real time in the second electronic device, the right side thereof, and a rear surface thereof, in an upper portion of the right side, a lower portion of the right side, and a lower portion of the left side, respectively, of the touch screen of the master electronic device.

When the master electronic device receives an input of an instruction that instructs to store an image photographed in the master electronic device, the master electronic device stores a presently photographed image in the master electronic device. For example, as shown in FIG. 6A, when the master electronic device receives an input of an instruction that instructs to record an image photographed in the master electronic device, the master electronic device stores an image of a front surface of a presently photographed subject in the master electronic device.

When the master electronic device receives selection of any one area of areas in which an image photographed in three slave electronic devices is being displayed, the master electronic device stores a photographed image displayed in the selected area.

For example, as shown in FIG. 6B, when the master electronic device receives selection of an area in which an image photographing the left side of a subject is being displayed, the master electronic device stores an image photographing the left side of the subject. Similarly, as shown in FIGS. 6C and 6D, when the master electronic device receives selection of an area in which images photographing the right side of the subject and a rear surface are being displayed, the master electronic device stores an image photographing the right side of the subject and an image photographing the rear surface of the subject, respectively.

In the above-described example, the master electronic device may sequentially store each image according to a time order in which the each image is stored. For example, when a stored time of an image photographed in an angle of the master electronic device is from 0 to 10 seconds and a stored time of an image photographed in an angle of the second electronic device to the fourth electronic device is from 11 to 15 seconds, from 16 to 25 seconds, and from 26 to 60 seconds, respectively, the master electronic device stores an image photographed in an angle of the master electronic device from 0 to 10 seconds, an image photographed in an angle of the second electronic device from 11 to 15 seconds, an image photographed in an angle of the third electronic device from 16 to 25 seconds, and an image photographed in an angle of the fourth electronic device from 26 to 60 seconds.

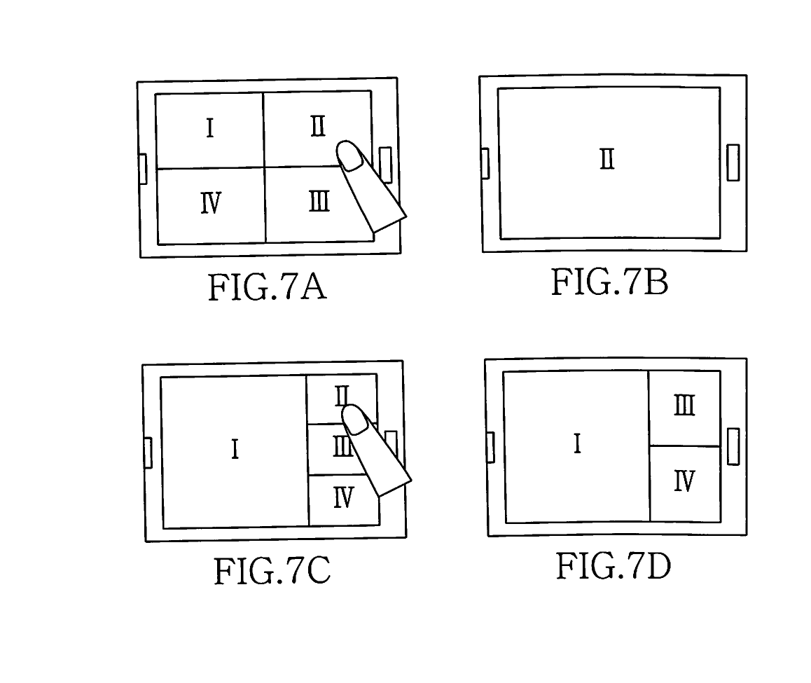

FIGS. 7A, 7B, 7C and 7D are diagrams illustrating enlarging and deleting an image which a master electronic device displays according to an embodiment of the present invention. Hereinafter, a case in which the master electronic device receives information of each image photographed in an angle of each electronic device from three slave electronic devices, divides the touch screen, and displays the image on a touch screen of the master electronic device, will be described.

The master electronic device receives selection of any one area of four areas that have been divided and in which three images II, III, and IV photographed in an angle of each of three slave electronic devices and an image I photographed in a present angle of the master electronic device are displayed. For example, as shown in FIGS. 7A and 7C, the master electronic device receives selection of an area, in which an image photographed in an angle of the second electronic device is displayed, among four areas.

After receiving the selection, the master electronic device enlarges and displays the image in the selected area by a preset size. For example, as shown in FIG. 7B, when the master electronic device receives selection of an area in which an image photographed in an angle of the second electronic device is displayed, the master electronic device enlarges and displays the image in the selected area on a touch screen of the master electronic device. Further, although not shown in FIG. 7, the master electronic device may reduce and display an image of a selected area by a preset size.

Here, the master electronic device may enlarge or reduce and display an image corresponding to the selected area and provide together with audio corresponding to the selected area. The master electronic device may provide audio collected in the master electronic device while displaying an image photographed in an angle of the master electronic device. When the master electronic device receives selection of an area corresponding to an image that is transmitted from the slave electronic device, the master electronic device may provide together with audio collected in real time in the slave electronic device that provides the image corresponding to the selected area while enlarging or reducing and displaying the image corresponding to the selected area.

Further, the master electronic device may terminate display of the image corresponding to the selected area. For example, as shown in FIG. 7D, when the master electronic device receives selection of an area in which an image photographed in an angle of the second electronic device is displayed, the master electronic device may terminate display of the image corresponding to the selected area.

Thus, a user of the master electronic device may determine the importance of an image photographed in various angles so that an image determined as more important than other images according to a preset method can be selected, enlarged and displayed. Further, the user of the master electronic device may delete an image determined as less important than other images and an image photographing in an unnecessary angle according to a preset method so that such image can be selected, reduced, and displayed.

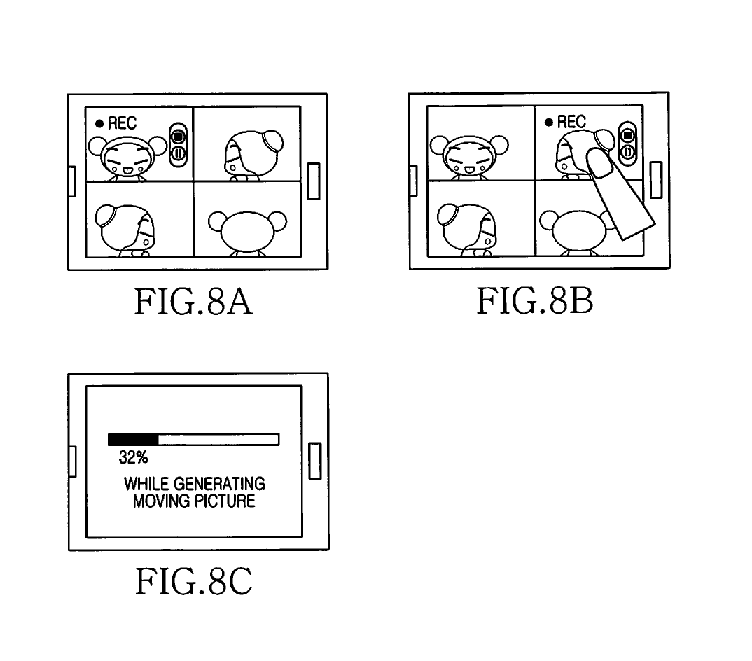

FIGS. 8A, 8B and 8C are diagrams illustrating a master electronic device editing an image stored by a master electronic device according to an embodiment of the present invention.

When the master electronic device receives an input of an instruction that instructs to store an image photographed in an angle of the master electronic device, the master electronic device stores an image in which the master electronic device is presently photographing. For example, as shown in FIG. 8A, when the master electronic device receives an input of an instruction that instructs to store an image photographed in an angle of the master electronic device, the master electronic device may store an image of a subject presently photographed in the master electronic device.

When any one area of display areas in which an image photographed in a slave electronic device is displayed, is selected, the master electronic device stores a photographed image displayed in the selected area. For example, as shown in FIG. 8B, when the master electronic device receives selection of a display area of an image photographing the left side of the subject, the master electronic device stores an image photographing the left side of the subject.

Here, the master electronic device may sequentially store each image with a preset resolution according to a time order in which the each image is stored. For example, in the master electronic device, a case in which a stored time of an image photographed with a resolution of WVGA in an angle of the master electronic device is from 0 to 300 seconds and a stored time of an image photographed with a resolution of HD in an angle of the second electronic device is from 301 to 600 seconds, will be described. In the above-described example, the master electronic device stores an image photographed in an angle of the master electronic device from 0 to 300 seconds and an image photographed in an angle of the second electronic device from 301 to 600 seconds.

When an input of an instruction that instructs to edit an image photographed in the master electronic device is received, the master electronic device may determine an image to be stored and generate a moving picture file according to a time order in which the image with a preset resolution is stored.

In the above-described example, as shown in FIG. 8C, the master electronic device generates a moving picture from a photographed image for a time of total 600 seconds as a file. More specifically, an image in which a front surface of a subject is photographed with a resolution of WVGA in a time range from 0 to 300 seconds and an image in which the left side of a subject is photographed with a resolution of HD in a time range from 301 to 600 seconds are used to generate a moving picture in a time range from 0 seconds to 600 seconds with different resolutions in different time segments.

As another example, the master electronic device generates a moving picture from a photographed image for a time of total 600 seconds as a file with a lowest resolution. That is, because a lowest resolution for a moving picture to be stored is a resolution of WVGA, the master electronic device uses an image in which the front surface of a subject is photographed with a resolution of WVGA in a time range from 0 to 300 seconds and an image in which the left side of a subject is photographed with a resolution of WVGA in a time range from 301 to 600 seconds to generate a moving picture with a resolution of WVGA.

As another example, the master electronic device generates a moving picture from a photographed image for a time of total 600 seconds as a file with a highest resolution. That is, because a highest resolution for a moving picture to be stored is a resolution of HD, the master electronic device uses an image in which the front surface of a subject is photographed with a resolution of HD in a time range from 0 to 300 seconds and an image in which the left side of a subject is photographed with a resolution of HD in a time range from 301 to 600 seconds to generate a moving picture with a resolution of HD.

As another example, the master electronic device generates a moving picture from a photographed image for a time of total 600 seconds as a file with a resolution according to a user's selection. For example, when the master electronic device receives selection of Full HD as a resolution of a file to be generated, the master electronic device uses an image in which a front surface of a subject is photographed with a resolution of Full HD in a time range from 0 to 300 seconds and uses an image in which the left side of a subject is photographed with a resolution of Full HD in a time range from 301 to 600 seconds to generate a moving picture with a resolution of Full HD.

Here, when the master electronic device generates a moving picture from an image photographed in each angle, the master electronic device may use stored audio together with each image. For example, when a stored time of an image photographed in an angle of the master electronic device is from 0 to 300 seconds and a stored time of an image photographed in an angle of the second electronic device is from 301 to 600 seconds, the master electronic device may store an image photographed in an angle of the master electronic device and audio collected in the master electronic device from 0 to 300 seconds, store an image photographed in an angle of the second electronic device and audio collected in the second electronic device, and use the images and the audios to generate a file from 301 to 600 seconds.

When the master electronic device according to an embodiment of the present invention receives an input of an instruction that instructs to edit a stored image, there is a merit that the master electronic device may generate a moving picture with a preset resolution including a plurality of images photographed with various angles.

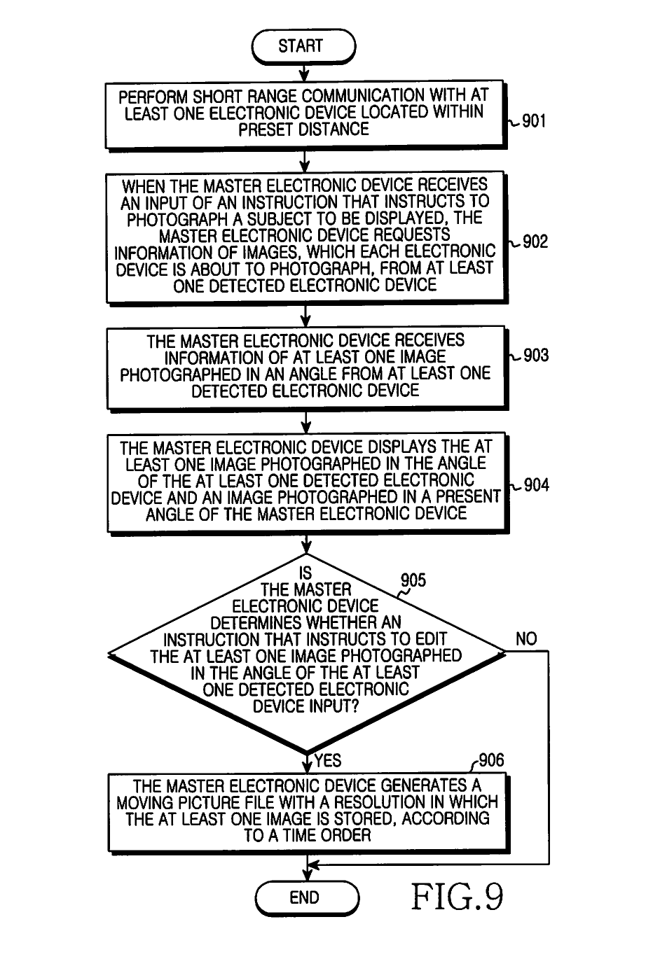

FIG. 9 is a flowchart illustrating an operation of a master electronic device according to an embodiment of the present invention.

As shown in FIG. 9, the master electronic device performs short range communication with at least one electronic device located within a preset distance in step 901. More specifically, the master electronic device performs short range communication such as Wi-Fi direct, Bluetooth, and Near Field Communication (NFC) with at least one electronic device among a preset plurality of slave electronic devices.

When the master electronic device receives an input of an instruction that instructs to photograph a subject to be displayed, the master electronic device requests information of images, which each electronic device is about to photograph, from at least one detected electronic device in step 902. That is, when the master electronic device receives an input of an instruction that instructs to photograph a subject to be displayed, the master electronic device requests information of images, which each slave electronic device is about to photograph, from a slave electronic device performing short range communication.

The master electronic device receives information of at least one image photographed in an angle from at least one detected electronic device in step 903. For example, when the master electronic device detects three electronic devices, the master electronic device receives information of three images photographed in an angle of three electronic devices.

The master electronic device displays the at least one image photographed in the angle of the at least one detected electronic device and an image photographed in a present angle of the master electronic device in step 904. More specifically, the master electronic device divides the screen and displays at least one image photographed in the angle of the at least one detected electronic device and an image photographed in a present angle of the master electronic device according to a preset resolution in a preset area. More specifically, the master electronic device divides the touch screen and displays the image I photographed in an angle of the master electronic device on a main screen in the left area of the touch screen of the master electronic device and the image II which a slave electronic device is photographing on a sub-screen in the right area of the touch screen of the master electronic device.

The master electronic device determines whether an instruction that instructs to edit the at least one image photographed in the angle of the at least one detected electronic device is input in step 905. More specifically, the master electronic device determines whether an instruction that instructs to edit images photographed in a plurality of angles of a plurality of detected electronic devices is input.

If an instruction that instructs to edit the at least one image photographed in the angle of the at least one detected electronic device is input, the master electronic device generates a moving picture file with a resolution in which the at least one image is stored, according to a time order in step 906. For example, when a stored time of an image photographed in an angle of the master electronic device is 0 to 300 seconds and a stored time of an image photographed in an angle of the second electronic device is from 301 to 600 seconds, and when the master electronic device receives an input that instructs to generate a moving picture file with a resolution of Full HD according to a user's selection, the master electronic device generates a moving picture from a photographed image for a time of total 600 seconds as a file with a resolution of Full HD. More specifically, an image in which a front surface of a subject is photographed with a resolution of Full HD in a time range from 0 to 300 seconds is used together with an image in which the left side of a subject is photographed with a resolution of Full HD in a time range from 301 to 600 seconds to generate a moving picture.

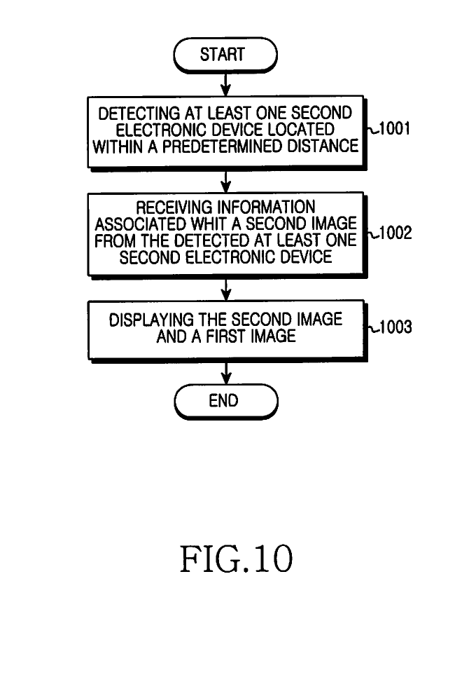

FIG. 10 is a flowchart illustrating a method of operating a master electronic device according to an embodiment of the present invention.

As shown in FIG. 10, the master electronic device detects at least one electronic device located within a preset distance among a plurality of slave electronic devices in step 1001. More specifically, the master electronic device detects at least one electronic device located within a preset distance using short range communication such as Wi-Fi direct, Bluetooth, and NFC with the at least one electronic device among a preset plurality of slave electronic devices.

The master electronic device receives information of at least one image photographed in an angle of the at least one detected electronic device from the at least one detected electronic device in step 1002. More specifically, the master electronic device receives an input of an instruction that instructs to photograph a subject to be displayed, requests information of an image, which each electronic device is about to photograph, from the at least one detected electronic device, and receives information of at least one image photographed in the angle of the at least one detected electronic device from the at least one detected electronic device.

The master electronic device displays the at least one image photographed in the angle of the at least one detected electronic device and an image photographed in a present angle of the master electronic device in step 1003. More specifically, the master electronic device divides the screen and displays the at least one image photographed in the angle of the at least one detected electronic device and an image photographed in a present angle of the master electronic device according to a preset resolution in a preset area.

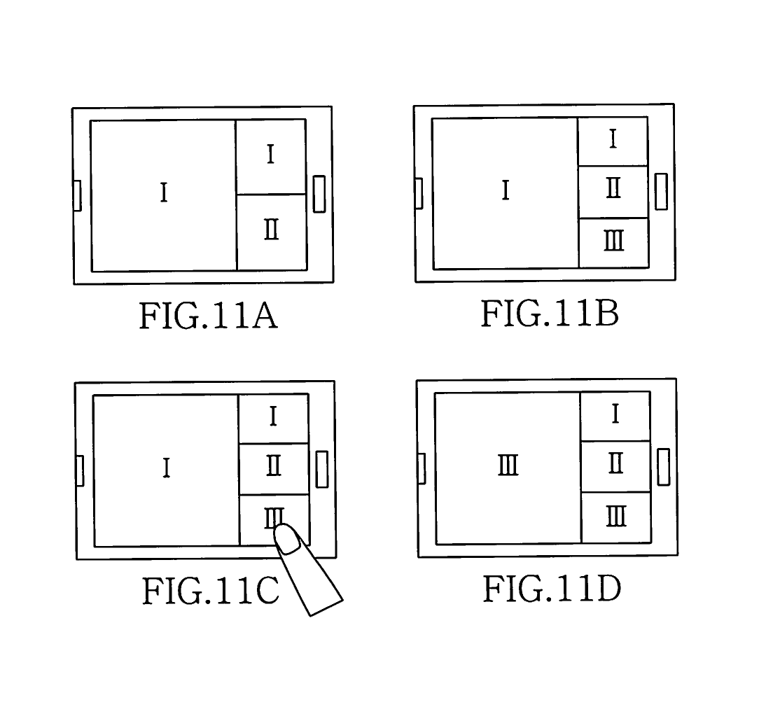

FIGS. 11A, 11B, 11C and 11D are diagrams illustrating enlarging and displaying an image in a selected area among images which a master electronic device displays according to an embodiment of the present invention.

When the master electronic device receives an input of an instruction that instructs to photograph a subject, the master electronic device displays a subject photographed in a present angle of the master electronic device on a touch screen of the master electronic device.

Here, the master electronic device may provide audio in which the master electronic device is collecting together with an image photographed in an angle of the master electronic device.

When the master electronic device detects the second electronic device among a preset plurality of slave electronic devices, the master electronic device requests to transmit information of an image photographed in a present angle of the second electronic device to the second electronic device performing short range communication with the master electronic device.

When the master electronic device receives information of the image, which the second electronic device is photographing, from the second electronic device, the master electronic device divides the touch screen and displays a first image I photographed in a present angle of the master electronic device and a second image II photographed in an angle of the second electronic device on the touch screen of the master electronic device.

For example, as shown in FIG. 11A, when the master electronic device receives information of an image from the second electronic device while displaying only the first image I on the touch screen of the master electronic device, the master electronic device divides the touch screen and displays the first image I and the second image II in the left side and the right side, respectively, of the touch screen. That is, the master electronic device divides the touch screen and displays both an image I of a subject photographed in an angle of the master electronic device and an image II of a subject photographed in an angle of the second electronic device on the touch screen of the master electronic device. The image I photographed in an angle of the master electronic device may be displayed in an area larger than the image II photographed in a slave electronic device so as to represent greater importance. More specifically, the master electronic device divides the touch screen and displays the image I photographed in an angle of the master electronic device on a main screen in the left area of the touch screen of the master electronic device and the image II which a slave electronic device is photographing on a sub-screen in the right area of the touch screen of the master electronic device.

When the master electronic device detects the third electronic device among a preset plurality of slave electronic devices, the master electronic device requests to transmit information of an image photographed in a present angle of the third electronic device to the third electronic device performing short range communication with the master electronic device.

When the master electronic device receives information of an image, which the third electronic device is photographing, from the third electronic device, the master electronic device divides the touch screen and displays a first image I photographed in a present angle of the master electronic device, a second image II photographed in an angle of the second electronic device, and a third image III photographed in an angle of the third electronic device on the touch screen of the master electronic device.

For example, as shown in FIG. 11B, the master electronic device displays the first image I on a main screen, which is a wide left area of the touch screen of the master electronic device, divide the remaining narrow right area of the touch screen, and displays the first image I, the second image II, and the third image III on a sub-screen, which is a narrow right area of the touch screen

When the master electronic device receives selection of any one area of areas displayed on the sub-screen, the master electronic device enlarges and displays an image in the selected area on a main screen.

For example, as shown in FIGS. 11C and 11D, when the master electronic device receives selection of an area III in a lower portion displayed on a sub-screen of the master electronic device, the master electronic device enlarges and displays an image in the selected area on the main screen. Here, the master electronic device enlarges and displays an image corresponding to the selected area and may provide together with audio corresponding to the selected area.

Here, the master electronic device detects the second electronic device and the third electronic device, but the master electronic device may detect four or more electronic devices and display an image photographed in various angles of four or more electronic devices.

Further, when the master electronic device displays images photographed in each electronic device, the master electronic device divides the touch screen and displays the images on the screen clockwise, or counterclockwise, according to a user's setting.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, a RAM, a memory chip, a device or an integrated circuit, or on an optically or magnetically readable medium such as, for example, a CD, a DVD, a magnetic disk or magnetic tape, or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the present invention has been particularly shown and described with reference to embodiments thereof, it will be understood by those skilled in the art that various changes in form and details may be made therein without departing from the spirit and scope of the present invention as defined by the appended claims and their equivalents.

What is claimed is:

1. A method in a first electronic device, the method comprising:
detecting at least one second electronic device located within a predetermined distance;
receiving information associated with a second image from the detected at least one second electronic device; and
displaying the second image and a first image,
wherein the first image is photographed in an angle of the first electronic device, and
wherein the second image is photographed in an angle of the detected at least one second electronic device.

2. The method of claim 1, further comprising performing short range communication with the at least one second electronic device located within the predetermined distance.

3. The method of claim 1, further comprising:
receiving an input of an instruction that instructs to photograph a subject to be displayed; and
requesting the information associated with the second image from the detected at least one second electronic device.

4. The method of claim 1, wherein displaying the first image and the second image comprises:
analyzing the information associated with the second image; and
dividing and displaying the first image and the second image on the touch screen.

5. The method of claim 1, further comprising:
receiving selection of any one area of at least two areas in which the second image and the first image are each being displayed on the touch screen; and
enlarging or reducing and displaying an image in the selected area by a preset size.

6. The method of claim 1, further comprising:
receiving selection of any one area of at least two areas in which the second image and the first image are each being displayed on the touch screen; and
terminating a display of an image in the selected area.

7. The method of claim 1, further comprising:
storing the first image in real time;
receiving selection of any one area of at least one area in which the second image is being displayed; and
storing an image in the selected area.

8. The method of claim 1, further comprising:
receiving an input of an instruction that instructs to edit at least one of the first image and the second image;
determining the at least one of the first image and the second image to be stored; and
generating a moving picture file according to a stored time order and a resolution.

9. The method of claim 8, wherein the generated moving picture file is a moving picture file including the at least one of the first image and the second image.

10. The method of claim 8, wherein the resolution is at least one of a preset resolution of the at least one of the first image and the second image, a lowest resolution of the at least one of the first image and the second image, a highest resolution of the at least one of the first image and the second image, and a selected resolution by a user.

11. A first electronic device comprising:
a display module; and
at least one processor configured to detect at least one second electronic device located within a predetermined distance, to receive information associated with a second image from the detected at least one second electronic device, and to display the second image and a first image,
wherein the first image is photographed in an angle of the first electronic device, and
wherein the second image is photographed in an angle of the detected at least one second electronic device.

12. The first electronic device of claim 11, further comprising a communication module configured to perform short range communication with the at least one second electronic device located within the preset distance.

13. The first electronic device of claim 11, wherein the display module is configured to receive an input of an instruction that instructs to photograph a subject to be displayed, and
wherein the communication module is configured to request the information associated with the second image from the detected at least one second electronic device.

14. The first electronic device of claim 11, wherein the processor is configured to analyze the information associated with the second image, and
wherein the display module is configured to divide and display an image photographed in the present angle and at least one image photographed in each angle at a preset location.

15. The first electronic device of claim 11, wherein the display module is configured to receive selection of any one area of at least two areas in which the second image and the first image are each being displayed on the touch screen and to enlarge or reduce and display an image in the selected area by a preset size.

16. The first electronic device of claim 11, wherein the display module is configured to receive selection of any one area of at least two areas in which the second image and the first image are each being displayed and to terminate a display of an image in the selected area.

17. The first electronic device of claim 11, further comprising a memory configured to store the first image in real time and to store an image in a selected area,
wherein the display module is configured to receive a selection of any one area of at least one area in which the second image is being displayed.

18. The first electronic device of claim 11, wherein the display module is configured to receive an input of an instruction that instructs to edit at least one of the first image and the second image, and
wherein the processor is configured to determine the at least one of the first image and the second image to be stored and to generate a moving picture file according to a stored time order and a resolution.

19. The first electronic device of claim 18, wherein the generated moving picture file is a moving picture file including the at least one of the first image and the second image.

20. The first electronic device of claim 18, wherein the resolution is at least one of a preset resolution of the at least one of the first image and the second image, a lowest resolution of the at least one of the first image and the second image, a highest resolution of the at least one of the first image and the second image, and a selected resolution by a user.
